(19) United States
(12) Patent Application Publication
(10) Pub. No.: US 2023/0373445 A1
(43) Pub. Date: Nov. 23, 2023

(54) Car Wash Conveyor Belt Lifting System

(71) Applicant: International Drying Corporation, Huntley, IL (US)

(72) Inventor: Arthur D. Stephens, JR., Prairie Grove, IL (US)

(21) Appl. No.: 18/134,696

(22) Filed: Apr. 14, 2023

Related U.S. Application Data
(60) Provisional application No. 63/344,697, filed on May 23, 2022.

(51) Int. Cl. B60S 3/00; B65G 21/22

(52) U.S. Cl. CPC B60S 3/004; B65G 21/22; B65G 2201/0294

(57) ABSTRACT

A car wash conveyor belt lifting system has a ground-level conveyor belt apparatus that is configured to move a vehicle through an automatic car wash system, wherein the conveyor belt has, at intervals along its length in the direction of travel, a plurality of rollers that effectively lift the conveyor belt from wear plates and other elements disposed beneath the conveyor belt to minimize wear on the belts, wear plates, and other elements and to easily allow cleaners and lubricants to be applied thereunder.

### CROSS-REFERENCE TO RELATED APPLICATIONS

The present invention claims priority to U.S. Prov. Pat. App. No. 63/344,697, titled “Car Wash Conveyor Belt Lifting System,” filed May 23, 2022, which is incorporated herein by reference in its entirety.

### TECHNICAL FIELD

The present invention relates to a vehicle-moving conveyor belt lifting system. Specifically, the vehicle-moving conveyor belt lifting system comprises a ground-level conveyor belt apparatus that is configured to move a vehicle, for example, through an automatic car wash system, wherein the conveyor belt has, at intervals along its length in the direction of travel, a plurality of spring-loaded rollers that effectively lift the conveyor belt from support plates and other elements disposed beneath the conveyor belt to minimize wear on the belts, support plates, and other elements and to easily allow cleaners and lubricants to be applied thereunder.

### BACKGROUND

Recently, conveyor belts have replaced car wheel track systems in automatic car washes to move vehicles through the automatic car washes. The conveyor belts typically have a relatively wide footprint so that a driver can drive his or her vehicle thereon without requiring the driver to have to aim for a relatively narrow track, which the drive may miss, causing damage to the track and to his or her vehicle.

The conveyor belt typically comprises lateral sections of metal or polymeric grating which are hingedly attached in series. The belt may rest and slide against one or more bracketed plates disposed therebeneath to provide support for vehicles that may be driven onto the conveyor belt. The conveyor belt typically travels from one end of an automatic car wash to another end, whereupon the conveyor belt wraps around a first toothed wheel system and travels beneath the bracketed plates back to its original starting point, whereupon the conveyor belt rotates along a second tooth wheel system. The first and second toothed wheel systems engage the conveyor belt and maintain the movement thereof and tautness of the conveyor belt on the bracketed plates.

As the conveyor belt moves on top of the bracketed plates, the conveyor belt contacts the bracketed plates, causing damage to either or both of the conveyor belt and the bracketed plates therebeneath. Over time, the frictional wear requires replacement of the conveyor belt and/or the bracketed plates, which can be costly and time consuming.

A need, therefore, exists for an improved vehicle-moving conveyor belt system. Specifically, a need exists for an improved vehicle-moving conveyor belt system that may be utilized to move vehicles within an automatic car wash. More specifically, a need exists for an improved vehicle-moving conveyor belt system that may move vehicles through an automatic car wash and minimizes wear to the conveyor belt and/or the support plates disposed therebeneath.

In addition, a need exists for an improved vehicle-moving conveyor belt system that effectively lifts the conveyor belt away from the support plates disposed therebeneath. Specifically, a need exists for an improved vehicle-moving conveyor belt system having a plurality of wheels disposed at internals along the length of the conveyor belt. More specifically, a need exists for an improved vehicle-moving conveyor belt system wherein the plurality of wheels utilized to lift the conveyor belt away from the support plates therebeneath are spring-loaded so that the same may be pressed down against the support plates when a vehicle travels thereover.

Further, a need exists for an improved vehicle-moving conveyor belt system that minimizes wear of the conveyor belt on elements. Specifically, a need exists for an improved vehicle-moving conveyor belt system that reduces the need for replacement of worn parts throughout the life of the vehicle-moving conveyor belt system.

### SUMMARY OF THE INVENTION

The present invention relates to a car wash conveyor belt lifting system. Specifically, the car wash conveyor belt lifting system comprises a ground-level conveyor belt apparatus that is configured to move a vehicle through an automatic car wash system, wherein the conveyor belt has, at intervals along its length in the direction of travel, a plurality of spring-loaded rollers that effectively lift the conveyor belt from plates and other elements disposed beneath the conveyor belt to minimize wear on the belts and other elements and to easily allow cleaners and lubricants to be applied thereunder.

To this end, in an embodiment of the present invention, a conveyor belt system is provided. The conveyor belt system comprises: a structural frame comprising a first end and a second end; a first wear plate disposed on a top of the structural frame; a conveyor belt configured to traverse over the first wear plate; and a conveyor belt lifting element disposed beneath the conveyor belt, wherein the conveyor lifting element is configured to lift the conveyor belt away from the first wear plate and allow the conveyor belt to traverse over the first wear plate without touching the wear plate in a vicinity around the lifting element.

In an embodiment, the first wear plate comprises a first slot, wherein the lifting element is disposed within the slot when it lifts the conveyor belt away from the first wear plate.

In an embodiment, the conveyor belt system further comprises a second wear plate disposed adjacent to the first wear plate.

In an embodiment, the conveyor belt system further comprises: a space between the first wear plate and the second wear plate, wherein the lifting element is disposed within the space between the first wear plate and the second wear plate when it lifts the conveyor belt away from the first wear plate.

In an embodiment, the conveyor belt system further comprises: a plurality of lifting elements disposed within the space between the first wear plate and the second wear plate.

In an embodiment, the lifting element is a roller.

In an embodiment, the roller comprises a gripping surface.

In an embodiment, the roller has a first position and a second position, wherein when the lifting element is in the first position, the lifting element lifts the conveyor belt away from the first wear plate and further wherein when the lifting element is in the second position, the lifting element allows the conveyor belt to contact the first wear plate in the vicinity of the lifting element.

In an embodiment, the roller is biased into the first position.

In an embodiment, the roller is biased into the first position with a spring.

In an embodiment, the roller is configured to move between the first position and the second position via a drawbar.

In an embodiment, the roller is attached to a roller shaft allowing the roller to freely roll thereon.

In an embodiment, the roller shaft is connected to a pivot shaft through a first plate, wherein movement of the drawbar causes the pivot shaft to rotate, thereby rotating the first plate around the pivot shaft and moving the rollers between the first position and the second position.

In an embodiment, the roller shaft comprises a plurality of rollers thereon.

In an embodiment, the first wear plate has a plurality of roller slots configured to align with the plurality of rollers disposed on the roller shaft.

In an embodiment, the drawbar is configured to move via a hydraulic cylinder.

In an embodiment, the hydraulic cylinder is attached to an end plate of the structural frame.

In an embodiment, the conveyor belt is configured to traverse over the top of the structural frame, wrap around the first end of the structural frame, traverse beneath the top of the structural frame, and wrap around the second end of the structural frame.

In an alternate embodiment, a car wash comprises the conveyor belt system.

It is, therefore, an advantage and objective of the present invention to provide an improved vehicle-moving conveyor belt system.

Specifically, it is an advantage and objective of the present invention to provide an improved vehicle-moving conveyor belt system that may be utilized to move vehicles within an automatic car wash.

More specifically, it is an advantage and objective of the present invention to provide an improved vehicle-moving conveyor belt system that may move vehicles through an automatic car wash and minimizes wear to the conveyor belt and/or the support plates disposed therebeneath.

In addition, it is an advantage and objective of the present invention to provide an improved vehicle-moving conveyor belt system that effectively lifts the conveyor belt away from the support plates disposed therebeneath.

Specifically, it is an advantage and objective of the present invention to provide an improved vehicle-moving conveyor belt system having a plurality of wheels disposed at internals along the length of the conveyor belt.

More specifically, it is an advantage and objective of the present invention to provide an improved vehicle-moving conveyor belt system wherein the plurality of wheels utilized to lift the conveyor belt away from the support plates therebeneath are spring-loaded so that the same may be pressed down against the support plates when a vehicle travels thereover.

Further, it is an advantage and objective of the present invention to provide an improved vehicle-moving conveyor belt system that minimizes wear of the conveyor belt on elements.

Specifically, it is an advantage and objective of the present invention to provide an improved vehicle-moving conveyor belt system that reduces the need for replacement of worn parts throughout the life of the vehicle-moving conveyor belt system.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates an exploded view of a vehicle-moving conveyor belt system (without a conveyor belt thereon) in an embodiment of the present invention.

FIG. 2 illustrates a perspective view of a vehicle-moving conveyor belt system (without a conveyor belt thereon) in an embodiment of the present invention.

FIG. 3 illustrates a close-up perspective view of a vehicle-moving conveyor belt system (without a conveyor belt) showing lifting rollers in an embodiment of the present invention.

FIG. 4 illustrates a close-up perspective view of a vehicle-moving conveyor belt system with a conveyor belt partially disposed thereon showing the conveyor belt lifted by lifting rollers in an embodiment of the present invention.

FIG. 5 illustrates a close-up perspective view of a vehicle-moving conveyor belt system with a conveyor belt disposed thereon and lifted by lifting rollers in an embodiment of the present invention.

FIG. 6 illustrates a perspective view of a vehicle moving conveyor belt system (without a conveyor belt thereon) in an alternate embodiment of the present invention.

FIG. 7 illustrates a perspective view of a roller assembly for a vehicle moving conveyor belt system in the alternate embodiment of the present invention.

### DETAILED DESCRIPTION OF THE PRESENTLY PREFERRED EMBODIMENTS

The present invention relates to a car wash conveyor belt lifting system. Specifically, the car wash conveyor belt lifting system comprises a ground-level conveyor belt apparatus that is configured to move a vehicle through an automatic car wash system, wherein the conveyor belt has, at intervals along its length in the direction of travel, a plurality of spring-loaded rollers that effectively lift the conveyor belt from plates and other elements disposed beneath the conveyor belt to minimize wear on the belts and other elements and to easily allow cleaners and lubricants to be applied thereunder.

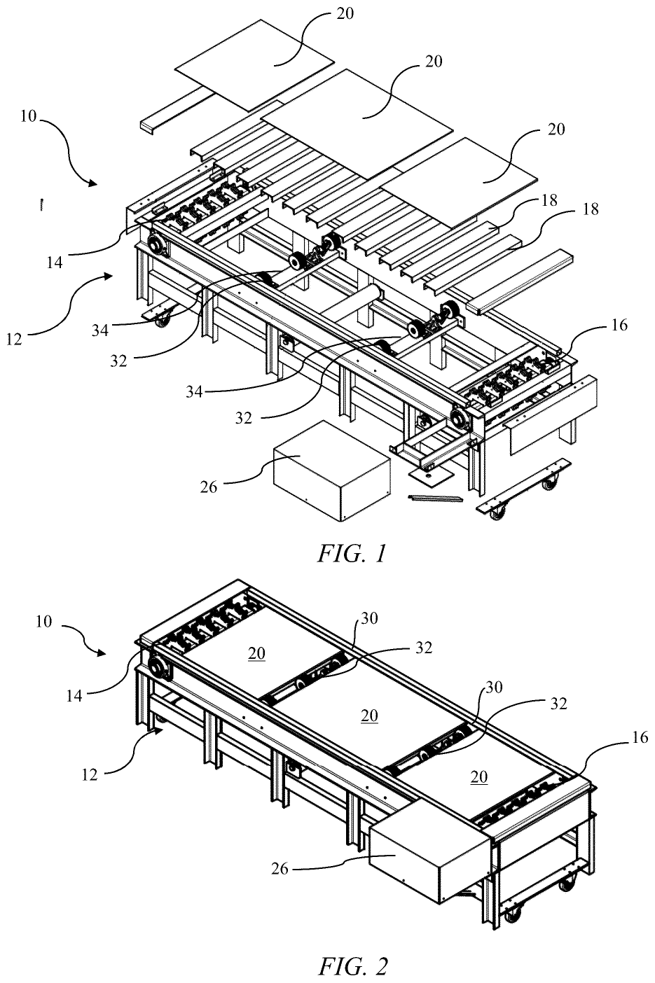

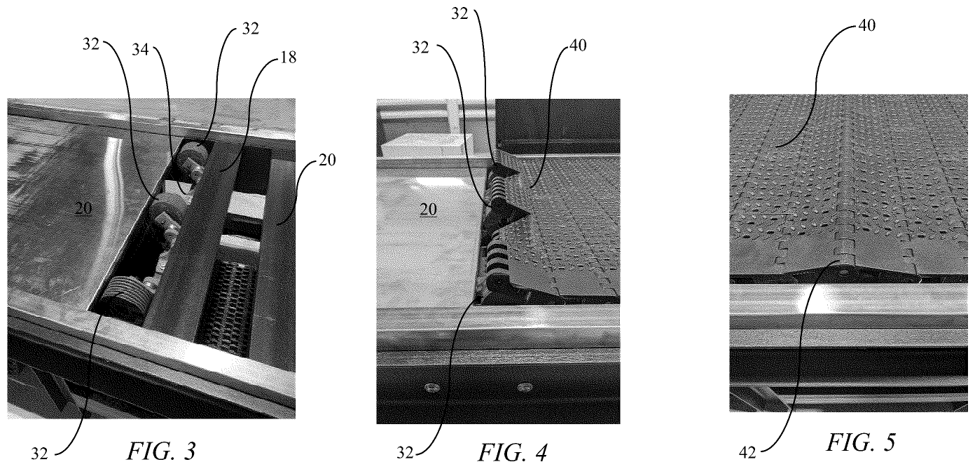

Referring now to the drawings, FIG. 1 illustrates an exploded perspective view of a vehicle-moving conveyor belt system 10 albeit without the conveyor belt thereon so that the structural plates and lifting rollers may be easily viewed. FIG. 2 illustrates a perspective view of the vehicle-moving conveyor belt system 10 without the conveyor belt in a non-exploded view. Specifically, the system 10 comprises a frame 12 on which a first beam 14 and a second beam 16 are disposed in parallel relationship to each other. Bridging the first and second beams 14, 16 may be a plurality of support brackets 18 that hold a plurality of support plates 20 thereon.

Disposed on opposite ends of the system 10 may be toothed wheels 22, 24 that may engage a conveyor belt (not shown in FIGS. 1 and 2), guiding the conveyor belt under the support brackets 18 and support plates 20 forming a loop. The toothed wheels 22, 24 engage the conveyor belt to move the same, driven by a motor that may be contained within motor housing 26, for example. Typically, the conveyor belts used in the present invention are made of metal or polymers, having a plurality of sections that are hinged together.

The support plates 20 may be disposed with gaps 30 therebetween, as shown in FIG. 2. Within the gaps 30 may be a plurality of rollers 32 that may be attached to a bridging bar 34. Each of the rollers 32 may have a roller surface that may sit higher than the surface of the support plates 20. Therefore, as the conveyor belt moves over the plurality of rollers within the gaps 30, the conveyor belt may be lifted away from the support plates 32, as illustrated in FIGS. 4-5. Specifically, FIG. 4 illustrates a conveyor belt 40 partially disposed on the system 10, showing how the rollers 32, disposed laterally across the system 10 on the bridging bar 34, may lift the conveyor belt away from the support plate 20. FIG. 5 illustrates the conveyor belt 40 fully disposed on the system 10, illustrating how the lifting rollers (not shown in FIG. 5) lift the conveyor belt 40 away from the support plates (not shown in FIG. 5), thereby forming a bump or hump 42 in the conveyor belt 40 as it runs over the support plates 20 and rollers 32.

The rollers may be biased into an extended position so that the surfaces of the rollers 32 may sit in a “high” position, such that the surfaces of the rollers 32 may sit higher than the support plates 20, thereby lifting the conveyor belt 40 as the conveyor belt 40 runs thereover. Therefore, as the conveyor belt 40 runs over the support plates 20 and the roller 32, the lifting of the conveyor belt 40 away from the support plates 20 may reduce the frictional wear caused by the conveyor belt that typically maintains constant contact with the support plates 20.

However, each of the rollers 32, or groups of rollers 32, may have a spring or other element that biases the rollers into the extended “high” position, but may allow the rollers to be pressed downwardly when an object of sufficient weight is disposed thereon. Thus, the rollers 32 may be pressed to the same level as the support plates 20 or below the level of the support plates 20 when a vehicle runs thereover, such as when a vehicle is moved by the conveyor belt 40.

Thus, the springs or other elements that bias the rollers to sit higher than the top surface of the support plates 20 may maintain the rollers in the high position even when the conveyor belt 40 runs thereover, thereby ensuring that the conveyor belt 40 is lifted away from the support plates 20. In other words, the conveyor belt 40 is preferably not of sufficient weight to press the rollers downwardly when running thereon. Only an object of significantly more weight than the conveyor belt 40, such as, for example, a vehicle (not shown), may press the rollers down when running thereon. Therefore, as a vehicle runs over the rollers 32, the rollers 32 may not cause the vehicle to lurch or bump upwards. The vehicle may therefore traverse the conveyor belt system as if the surface is flat.

Although FIGS. 1 and 2 show only two gaps 30 having rollers therein, it should be noted that the vehicle-moving conveyor belt system 10 of the present invention may include any number of gaps 30 and any number of rollers 32 within the gaps. Thus, if a conveyor belt system of the present invention is longer than shown in FIGS. 1 and 2, the desired numbers of rollers can be incorporated therein.

Moreover, the bumps 42 created by the rollers 32, as illustrated in FIG. 5, may allow a technician or other user to easily administer cleaners and/or lubricants thereunder. Specifically, the bump 42 may provide a gap sufficient to allow a user to spray chemicals thereunder, which may make it easier to apply these materials without requiring disassembly of the system 10.

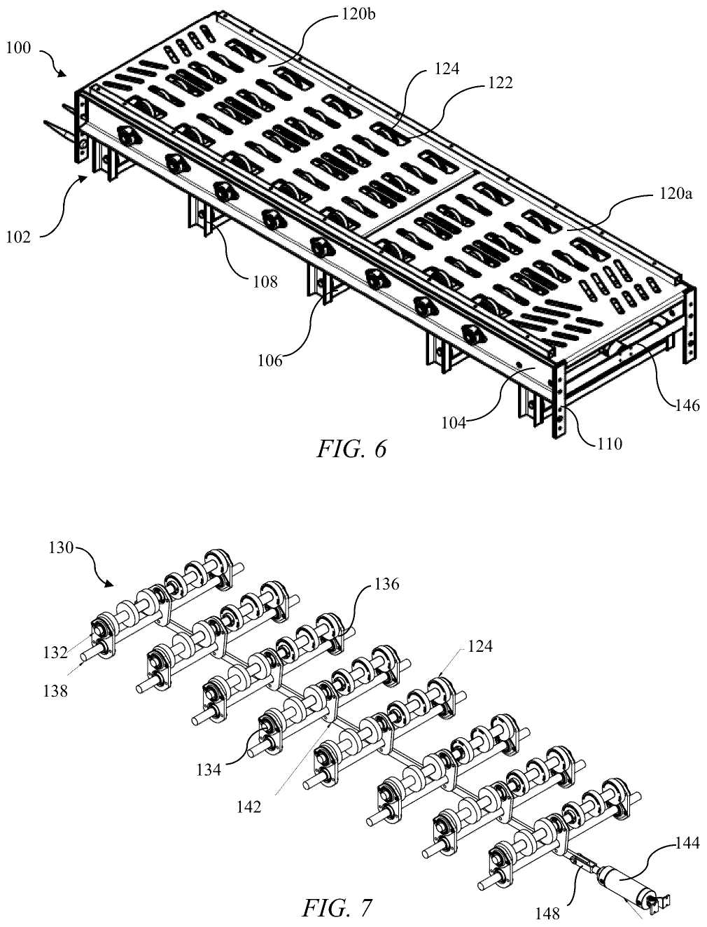

Referring now to FIGS. 6 and 7, a vehicle-moving conveyor system 100 is illustrated and described herein in an alternate embodiment of the present invention. The system 100 comprises a structural frame 102 having a plurality of structural components, such as side bars 104, legs 106, leg cross-braces 108, corner struts 110, and other like structural components that may rigidly hold the system 100 together. Disposed on a top of the system 100 may be a plurality of wear plates 120a, 120b that may be disposed side-by-side thereby providing a surface for a conveyor belt (not shown) to traverse, especially with a vehicle thereon.

The wear plates 120a, 120b may have a plurality of roller slots 122 therein, each of which may have a roller 124 therein. The rollers 124 may be made from a gripping material, such as, for example, a urethane material. Moreover, the rollers 124 may extend upwardly through the roller slots 122 from beneath the wear plates 120a, 120b, and may act to push the conveyor belt (not shown) away from the wear plates 120a, 120b. Specifically, the conveyor belt may roll on the rollers 124 when disposed through the roller slots 122 to push the conveyor belt away from the wear plates 120a, 120b, thereby preventing and/or minimizing wear of the conveyor belt and/or the wear plates 120a, 120b. In a situation where there is no weight on the conveyor belt caused by a vehicle passing thereover, the rollers 124 may be extended through the roller slots 122 to minimize wear, as described above.

The rollers 124 may descend through the roller slots 122 so that the conveyor belt consequently falls and contacts the wear plates 120a, 120b. Specifically, when a vehicle passes on a top of the conveyor belt and the conveyor belt moves the vehicle over the system 100, the rollers 124 may be in a descended position so that the wear plates 120a, 120b fully support the weight of the vehicle thereon.

The rollers 124 may extend to a high position through the roller slots 122 and descend to a low position so that the rollers 124 do not contact the conveyor belt so that the wear plates may bear the full weight of the vehicle thereon, as described above. As noted above, the rollers may be biased upwardly through use of a spring or other like element. The conveyor belt may then automatically lower to the wear plates 120a, 120b when a vehicle passes thereover.

FIG. 7 illustrates an alternate roller system 130 in an embodiment of the present invention. Specifically, the rollers 124 may be positioned laterally along roller shafts 132 and may be spaced accordingly in alignment with the roller slots 122 within the wear plates 120a, 120b, as shown in FIG. 6. Spacers and lock collars, for example, may be utilized to fix the rollers in their respective positions on the roller shafts 132, which may allow each of the rollers 124 to freely roll.

A first roller holding plate 134 and a second roller holding plate 136 may connect each roller shaft 132 to a pivot shaft 138. A lever plate 140 may be disposed between first and second roller holding plates 134, 136, tying the roller shaft 132 to the pivot shaft 138. The lever plate 140 may also be attached to a drawbar 142 on a bottom of each lever plate 140 that may move back and forth longitudinally due to movement from a hydraulic cylinder 144 which may be pivotally attached to an end plate 146 (as shown in FIG. 6). The hydraulic cylinder 144 may be connected to the drawbar 142 via a clevis pin 148. As the hydraulic cylinder 144 moves the drawbar 142, the lever plate 140 may rotate at the pivot shaft 138, which may cause the roller shaft 132 to ascend or descend, depending on the movement of the drawbar 142, thereby causing the rollers 124 to ascend through the roller slots 122 or descend therethough the same.

When a conveyor belt is running over the system 100 without a vehicle thereon, the hydraulic cylinder 144 may move the drawbar 142 to move the rollers 124 into their high position, thereby pushing the conveyor belt upwardly away from the wear plates 120a, 120b, thereby eliminating or minimizing wear of the wear plates 120a, 120b and/or the conveyor belt thereon. As a vehicle is moved onto the conveyor belt, the hydraulic cylinder 144 may move the drawbar 132 to move the rollers 124 into their low position, thereby dropping the conveyor belt downwardly onto the wear plates 120a, 120b so that the wear plates 120a, 120b may bear the full weight of the vehicle as it traverses on the conveyor belt thereon. Once the vehicle passes the conveyor belt completely, the hydraulic cylinder 144 may move the drawbar 142 to move the rollers 124 into their high positions once again, thereby pushing the conveyor belt upwardly away from the wear plates 120a, 120b. The movement of the rollers 124 may continue up and down as vehicles move onto and off of the conveyor belt disposed thereon.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A conveyor belt system comprising:
a structural frame comprising a first end and a second end;
a first wear plate disposed on a top of the structural frame;
a conveyor belt configured to traverse over the first wear plate;
a conveyor belt lifting element disposed beneath the conveyor belt, wherein the conveyor lifting element is configured to lift the conveyor belt away from the first wear plate and allow the conveyor belt to traverse over the first wear plate without touching the wear plate in a vicinity around the lifting element.

2. The conveyor belt system of claim 1 wherein the first wear plate comprises a first slot, wherein the lifting element is disposed within the slot when it lifts the conveyor belt away from the first wear plate.

3. The conveyor belt system of claim 1 further comprising a second wear plate disposed adjacent to the first wear plate.

4. The conveyor belt system of claim 3 further comprising:
a space between the first wear plate and the second wear plate, wherein the lifting element is disposed within the space between the first wear plate and the second wear plate when it lifts the conveyor belt away from the first wear plate.

5. The conveyor belt system of claim 4 further comprising:
a plurality of lifting elements disposed within the space between the first wear plate and the second wear plate.

6. The conveyor belt system of claim 4 wherein the lifting element is a roller.

7. The conveyor belt system of claim 1 wherein the lifting element is a roller.

8. The conveyor belt system of claim 7 wherein the roller comprises a gripping surface.

9. The conveyor belt system of claim 7 wherein the roller has a first position and a second position, wherein when the lifting element is in the first position, the lifting element lifts the conveyor belt away from the first wear plate and further wherein when the lifting element is in the second position, the lifting element allows the conveyor belt to contact the first wear plate in the vicinity of the lifting element.

10. The conveyor belt system of claim 9 wherein the roller is biased into the first position.

11. The conveyor belt system of claim 10 wherein the roller is biased into the first position with a spring.

12. The conveyor belt system of claim 9 wherein the roller is configured to move between the first position and the second position via a drawbar.

13. The conveyor belt system of claim 12 wherein the roller is attached to a roller shaft allowing the roller to freely roll thereon.

14. The conveyor belt system of claim 13 wherein the roller shaft is connected to a pivot shaft through a first plate, wherein movement of the drawbar causes the pivot shaft to rotate, thereby rotating the first plate around the pivot shaft and moving the rollers between the first position and the second position.

15. The conveyor belt system of claim 13 wherein the roller shaft comprises a plurality of rollers thereon.

16. The conveyor belt system of claim 15 wherein the first wear plate has a plurality of roller slots configured to align with the plurality of rollers disposed on the roller shaft.

17. The conveyor belt system of claim 12 wherein the drawbar is configured to move via a hydraulic cylinder.

18. The conveyor belt system of claim 17 wherein the hydraulic cylinder is attached to an end plate of the structural frame.

19. The conveyor belt system of claim 1 wherein the conveyor belt is configured to traverse over the top of the structural frame, wrap around the first end of the structural frame, traverse beneath the top of the structural frame, and wrap around the second end of the structural frame.

20. A car wash comprising the conveyor belt system of claim 1.
